(19) United States
(12) Patent Application Publication
(10) Pub. No.: US 2025/0017795 A1
(43) Pub. Date: Jan. 16, 2025

(54) Apparatus and Method for Storing Articles in a Healthcare Environment

(71) Applicant: Care-Stow, LLC, Rockford, IL (US)

(72) Inventors: Russell Saari, Beloit, WI (US); John Cashmore, Woodstock, IL (US); Roger Crook, Rockford, IL (US)

(73) Assignee: Care-Stow, LLC, Rockford, IL (US)

(21) Appl. No.: 18/517,447

(22) Filed: Nov. 22, 2023

Related U.S. Application Data
(60) Provisional application No. 63/478,630, filed on Jan. 5, 2023.

(51) Int. Cl. A61G 7/05; A61G 9/00; F16B 2/08

(52) U.S. Cl. CPC A61G 7/0503; A61G 9/006; F16B 2/08

(57) ABSTRACT

A storage system for articles in a healthcare environment which includes a containment unit, a universal slide mount, and a fastener. The containment unit has a back wall with two protruding rails, and may be of any shape or size to hold articles commonly found in a healthcare environment. In one embodiment of the invention, the containment unit is shaped to hold a standard sized urinal. The universal slide mount has a front side with two slots which are capable of receiving the rails of the containment unit to reversibly attach the containment unit to the universal slide mount. The universal slide mount also has a back side with openings to attach the fastener to the universal slide mount. The fastener can be any known method to attach the universal slide mount to an environmental surface. In one embodiment of the invention, the fastener is a reversible zip tie.

### BACKGROUND OF THE INVENTION

The present invention generally relates to a storage system for articles in a healthcare environment. More particularly, the present invention relates to an apparatus and method for convenient, sanitary, and customizable storage of urinals in healthcare settings.

Storage systems for healthcare equipment, and particularly for urinals, generally consist of a containment portion, which is designed to hold the standard shape of a portable urinal, and a fastening portion, which functions to connect the containment portion holding the urinal to a surface in the healthcare setting, often the rail of a medical bed.

A urinal bottle holding apparatus is disclosed in Cox U.S. Pat. No. 11,234,545. Cox discloses a urinal bottle holder, designed to hold the handle of industry standard urinal bottles, with an attachment mechanism which slidably attaches the urinal bottle holder to a mounting hook. The mounting hook disclosed by Cox is made of a flexible material so the mounting hook can be extended and engaged around a horizontal cylindrical and/or elongated surface.

A universal mount urinal holder is disclosed in Boettger et al. 5626318. Boettger discloses a receptacle holder assembly including a receptacle holder unit and a pair of attachment members. The receptacle holder disclosed by Boettger is formed out of wire. The attachment members each contain a spiral-like convoluted passageway into which the receptacle holder may be inserted. The attachment members, connected with the receptacle holder, may be adhesively attached to a desired support surface.

A method for caring for a bedbound patient using a portable bedside toileting storage system is disclosed in Cregg US2012/0273445. Cregg discloses providing a plurality of storage containers, each container intended to hold various articles commonly found in a healthcare setting. The storage containers may be reversibly attached to a wheeled support pole via a releasable clamp which is tightened using a hand-turned knob or wing nut.

### BRIEF SUMMARY OF THE INVENTION

One or more of the embodiments of the present invention provide a system and method for storing medical equipment in a healthcare setting. The system includes a plurality of containment units each designed to hold a health-related article commonly found in a healthcare setting. The system also includes a slide mount unit which is particularly molded to reversibly couple with one of the plurality of containment units. The system also includes a fastening means capable of securely and reversibly attaching the slide mount unit, together with the containment unit, to a variety of surfaces commonly found in a healthcare setting.

### BRIEF DESCRIPTION OF THE DRAWINGS

FIG. 1 illustrates a disassembled view of a healthcare storage apparatus according to an embodiment of the present invention.

FIG. 2a illustrates a top view of a strap according to an embodiment of the present invention.

FIG. 2b illustrates a side view of a strap according to an embodiment of the present invention.

FIG. 2c illustrates a bottom view of a strap according to an embodiment of the present invention.

FIG. 2d illustrates a strap according to an embodiment of the present invention as it is used in a healthcare environment.

FIG. 3a illustrates a front view of a universal slide mount according to an embodiment of the present invention.

FIG. 3b illustrates a rear view of a universal slide mount according to an embodiment of the present invention.

FIG. 4 illustrates a containment unit according to an embodiment of the present invention.

FIG. 5 illustrates an embodiment of the present invention as it is used in a healthcare environment.

### DETAILED DESCRIPTION OF THE INVENTION

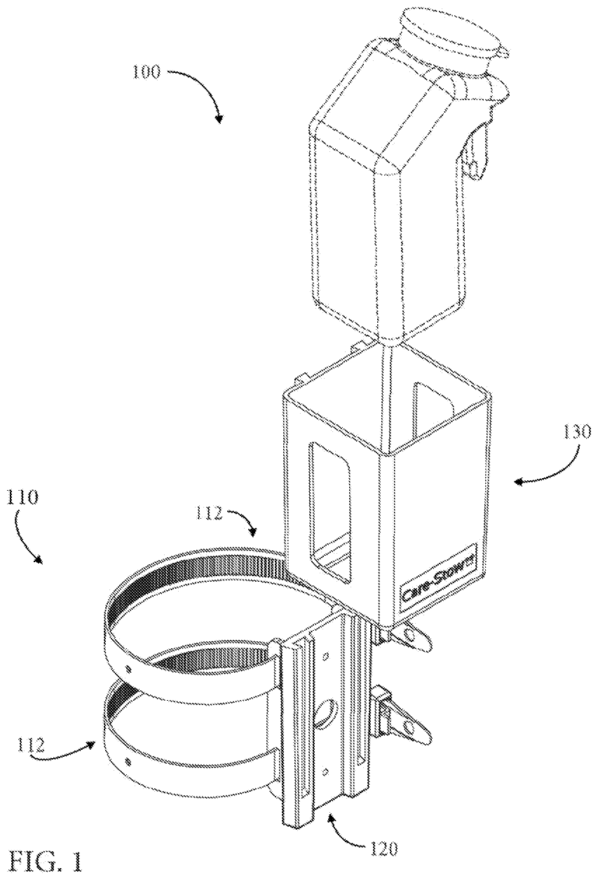

FIG. 1 illustrates a healthcare storage apparatus 100 according to an embodiment of the present invention. The healthcare storage system 100 includes a fastener 110, a universal slide mount 120, and a containment unit 130. In this embodiment, the fastener 110 consists of two identical strap 112. In operation, the containment unit 130 is reversibly connected to the universal slide mount 120. The two strap 112 are reversibly connected to the universal slide mount 120 in a lateral configuration. In operation, the two strap 112 are reversibly secured onto an environmental surface.

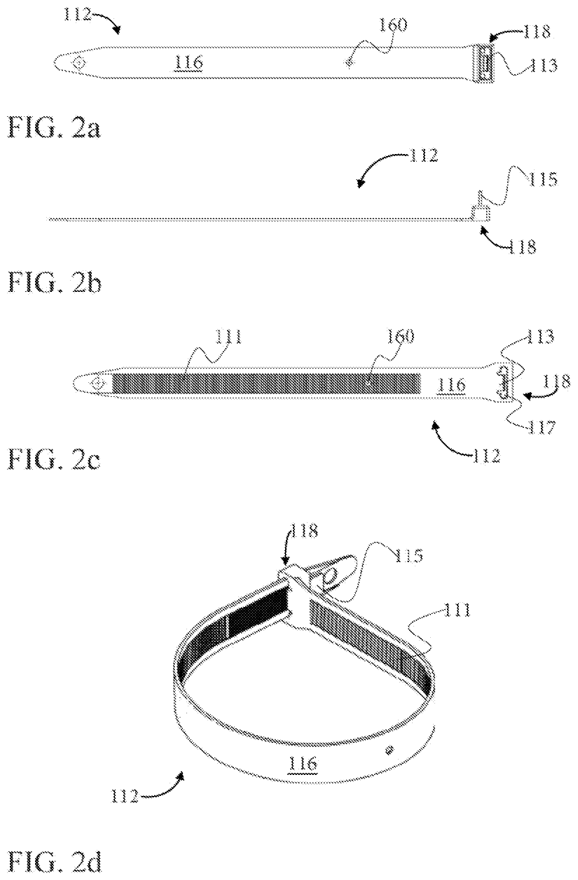

FIG. 2a illustrates the top of the strap 112, FIG. 2b illustrates the side of the strap 112, and FIG. 2c illustrates the bottom of the strap 112. The strap 112 comprises a straight section 116 and a releasable locking head 118. The straight section 116 comprises a plurality of grooves 111 which are laterally integrated onto one side of the straight section 116. The head 118 is terminally connected to the straight section 116. The head 118 comprises an opening with a locking mechanism 113 which extends across the length of the opening. The locking mechanism 113 comprises a plurality of teeth 117 and a release tab 115. The release tab 115 of the locking mechanism 113 extends outward from the head 118 perpendicular to the straight section 116. The locking mechanism is configured to allow a user to move the release tab 115 to cause the locking mechanism 113 to move into different positions: a locked position and an unlocked position.

FIG. 2d illustrates the strap 112 in operation. In operation, the straight section 116 of the strap 112 is inserted into the opening of the head 118, so that the plurality of grooves 111 on the strap 112 are facing the plurality of teeth 117 on the locking mechanism 113. When the strap 112 is secured to a surface in the environment, the plurality of teeth 117 interlock with the plurality of grooves 111 in a way which prevents the straight section 116 from sliding free of the head 118. The plurality of grooves 111 and plurality of teeth 117 must be of appropriate shape and depth to allow the locking mechanism 113 to freely slide over the plurality of grooves 111 when the locking mechanism 113 is in the unlocked position, but prevent the locking mechanism 113 from moving over the plurality of grooves 111 when the locking mechanism 113 is in locked position, until the release tab 115 is depressed by a user.

In one embodiment, the locking mechanism 113 automatically moves into the locked position as the straight section 116 of the strap 112 is inserted into the head 118 in the manner of a zip tie. In this embodiment, a user manually depresses the release tab 115 toward the strap 112, which action causes the locking mechanism 113 to move into the unlocked position where the locking mechanism 113 is lifted away from the plurality of grooves 111. In this embodiment, when the release tab 115 is not manually depressed, the locking mechanism 113 remains in the locked position.

In another embodiment, to move the locking mechanism 113 into the locked position, a user must manually lift the release tab 115 away from the strap 112. In this embodiment, when a user depresses the release tab 115, the locking mechanism 113 remains in the unlocked position until a user lifts the release tab 115.

The strap 112 may be formed out of any flexible material including, but not limited to, plastics, fabrics, silicones, or rubbers. The strap 112 may be of any length or width. The strap 112 may be secured to a surface in the environment by any variation of known locking or releasable fasteners, including but not limited to, a Velcro, tied, clip on, magnetic, screw in, or tape on fastenings.

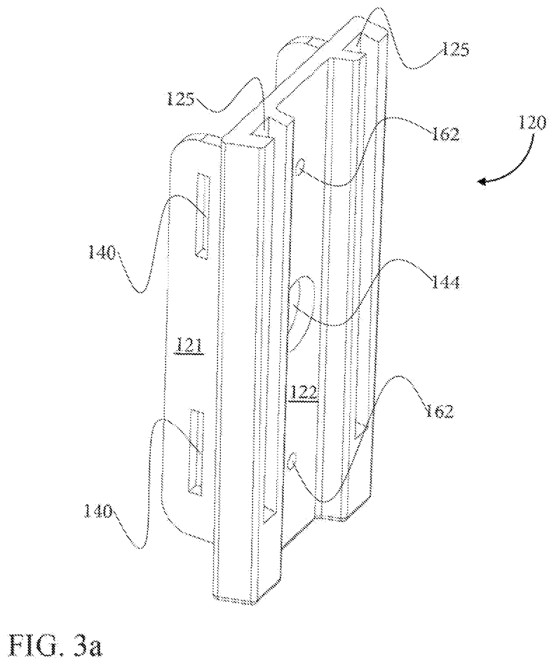

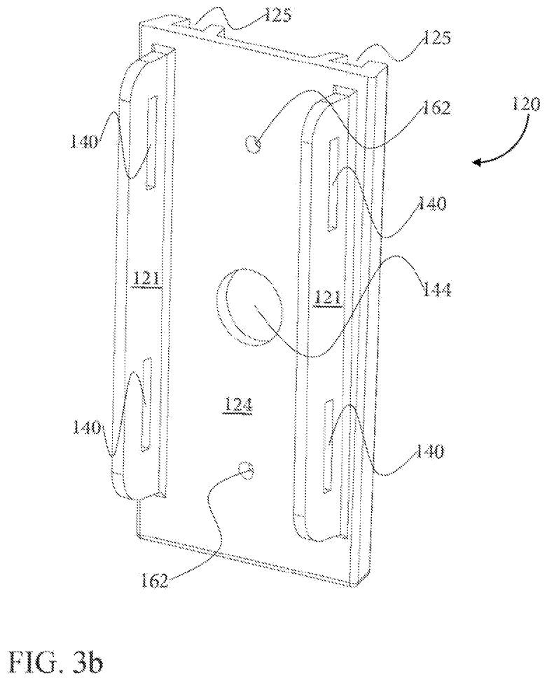

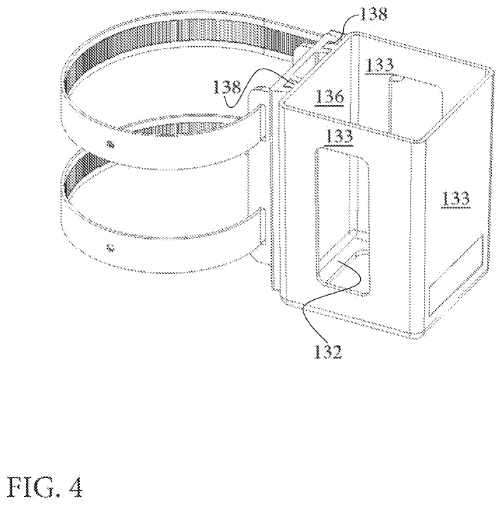

FIG. 3a illustrates a front view of the universal slide mount 120 according to an embodiment of the present invention, and FIG. 2b illustrates a rear view of the universal slide mount 120. The universal slide mount 120 consists of a front surface 122 and a rear surface 124. In one embodiment, the front surface 122 comprises a plurality of slot 125. The universal slide mount 120 could comprise any number of slot 125 on the front surface 122. The slot 125 may be of any shape or size and in any configuration on the front surface 122 of the universal slide mount 120, with the limitation that the slot 125 is capable of reversibly and securely receiving and holding the containment unit 130 as described in FIG. 4. In the present embodiment, the front surface 122 comprises two identical copies of slot 125 which are embedded into the front surface 122. In one embodiment, the two copies of slot 125 are symmetrically positioned about a sagittal plane. In another embodiment, the front surface 122 comprises a single slot 125. In one embodiment, the slot 125 is the shape of a dovetail groove.

The rear surface 124 consists of a plurality of strap receivers 121. The plurality of strap receivers 121 are laterally integrated onto the rear surface 124 of the universal slide mount 120. In the present embodiment, the rear surface 124 consists of a pair of identical strap receiver 121 which are laterally integrated onto the rear surface 124 and are symmetrically positioned about a sagittal plane. The strap receiver 121 comprises a plurality of strap openings 140. The plurality of strap openings 140 traverse through the strap receiver 121, creating empty spaces to insert the plurality of strap 112. In one embodiment, each strap receiver 121 comprises two strap opening 140.

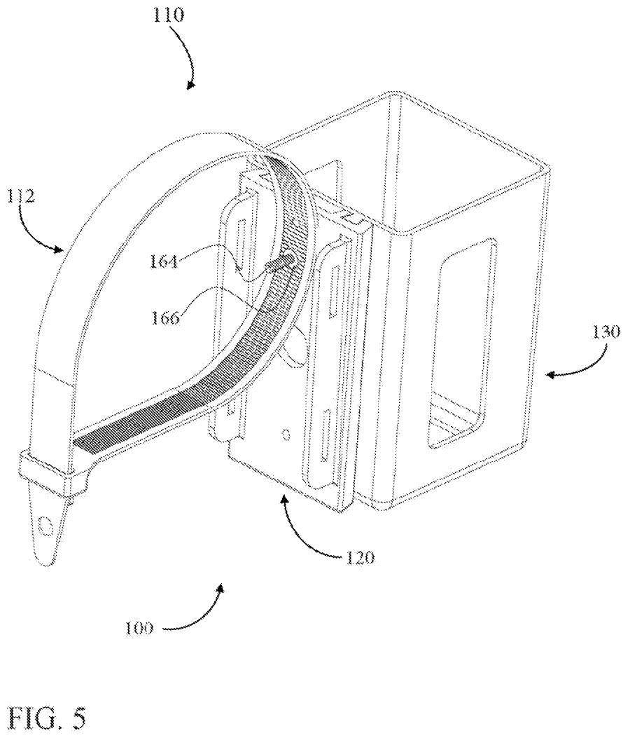

In one embodiment, the universal slide mount 120 also includes a plurality of screw holes 162 that are an appropriate width to receive standard screws. The plurality of screw holes 162 traverse through the front surface 122 and the rear surface 124 to create an empty space in the universal slide mount 120 to insert a screw. In one embodiment, the universal slide mount 120 also includes a center hole 144. The center hole 144 traverses through the front surface 122 and the rear surface 124 to create an empty space to insert a fastening mechanism. In one embodiment, the strap 112 is inserted into the hole 144 and is used to fasten the universal slide mount 120 to an environmental surface in a hanging configuration as described in FIG. 5. The universal slide mount 120 may be formed out of any material including, but not limited to, plastics, metals, or silicones.

FIG. 4 illustrates one embodiment of the containment unit 130. In this embodiment, the containment unit 130 is a urinal bottle holder that is shaped to secure an industry standard urinal bottle. In this embodiment, the containment unit 130 comprises a square base 132, a back wall 136, and three identical copies of side wall 133. The back wall 136 and the three side wall 133 terminally connect to the four edges of the square base 132, forming a four sided rectangular container with a top opening. The back wall 136 comprises a plurality of rail 138. The containment unit 130 may comprise any number of rail 138 on the back wall 136. The rail 138 may be of any shape or size and in any configuration on the back wall 136 of the containment unit 130, with the limitation that the rail 138 is able to slide into the slot 125 on the universal slide mount 120 in a reversable and secure manner. In the present embodiment, the back wall 136 comprises two identical copies of rail 138 which are laterally integrated onto the back wall 136. In one embodiment, the two copies of rail 138 are symmetrically positioned about a sagittal plane. In another embodiment, the back wall 136 comprises a single rail 138. In operation, in the present embodiment, a urinal bottle can be inserted into the opening created by the three side wall 133 and the back wall 136 so that the bottom of the urinal bottle lies flat against the square base 132. The three side wall 133 and the back wall 136 each act as structural walls to securely hold a standard sized urinal bottle.

The containment unit 130 could be any shape or size, provided that the plurality of rail 138 attached to the containment unit 130 are capable of sliding into slot 125 of the universal slide mount 120 in order to frictionally attach the containment unit 130 to the universal slide mount 120. Other shapes for the containment unit 130 include, but are in no way limited to, a clam shell case for storing glasses, a circular unit for securing beverage containers, or a rectangular unit for holding personal bags such as a purse. Each of the containment unit 130 is freely interchangeable with the universal slide mount 120 to meet the current storage needs of the user. The containment unit 130 may be formed out of any material including, but not limited to, plastics, metals, or silicones.

FIG. 1 and FIG. 4 describe one embodiment of the present invention as it is used in a healthcare environment. This embodiment consists of two identical copies of the strap 112, the universal slide mount 120, and the containment unit 130. In operation, the two identical copies of the strap 112 are inserted into the plurality of strap openings 140 so that the two strap 112 are reversibly connected to the two strap receiver 121 of the universal slide mount 120 in a parallel configuration to one another.

Next, each of the strap 112 is wrapped around a surface in the environment. The strap 112 is secured to the environmental surface when the straight section 116 is inserted into the loop 118, and the straight section 116 is pulled through the loop 118 until the rear surface 124 of the universal slide mount 120 is flush against the environmental surface. The universal slide mount 120 should be secured so that the openings of the slot 125 is at the top of the apparatus.

Next, the containment unit 130 is reversibly attached to the universal slide mount 120. Each of the rail 138 of the containment unit 130 is slidably engaged through the opening of each of the slot 125 so, in operation, the back wall 136 of the containment unit 130 is flush with the front surface 122 of the universal slide mount 120. An article is placed inside the containment unit 130.

FIG. 5 illustrates the healthcare storage apparatus 100 according to another embodiment of the present invention. This embodiment of the healthcare storage system 100 includes one of the strap 112, a screw 164, a nut 166, the universal slide mount 120, and the containment unit 130. In this embodiment, the containment unit 130 is reversibly attached to the universal slide mount 120 and the strap 112 is reversibly attached to the universal slide mount 120 in a vertical configuration. In operation, the screw 164 is inserted through the universal slide mount 120 and the strap 112. The nut 166 is twisted onto the end of the screw 164 to secure the strap 112 to the universal slide mount 120. In operation, the strap 112 is reversibly attached to an environmental surface causing the healthcare storage apparatus to be secured in a hanging position. In this embodiment, the strap 112 has at least one hole 160 which is an appropriate diameter to receive and hold the screw 164. In this embodiment, the universal slide mount 120 also has a hole 162 which traverses through the universal slide mount 120. The hole 162 should be the same diameter as the hole 160 and be an appropriate size to receive and hold the screw 164. The strap 112 may additionally be attached to the universal slide mount 120 in the configuration demonstrated in FIG. 5 using any known method of fastening, including but not limited to Velcro, adhesive, or clip on attachments. In another embodiment of the present invention, the strap 112 is inserted through the hole 144.

In all embodiments, a user may place any loose article into the containment unit 130. In operation, a user may detach the entire healthcare storage apparatus 100 from the environmental surface and re-attach the healthcare storage apparatus to another environmental surface as needed by releasing the strap(s) 112. A user may, alternatively, detach only the containment unit 130 from the universal slide mount 120 for cleaning, leaving the strap(s) 112 secured to the environmental surface and the universal slide mount 120. The containment unit 130 can be any size and shape and all possible embodiments of the containment unit 130 are freely interchangeable with the universal slide mount 120.

1. A universal mounting apparatus for use in a healthcare environment, said apparatus comprising
a. An anterior surface and a posterior surface;
b. Said anterior surface comprising one or more elongated slots, wherein each of said slots are particularly molded to accept a rail, said rail being permanently attached to a storage attachment, enabling said storage attachment to be reversibly attached to said anterior surface of said universal mounting apparatus;
c. Said posterior surface comprising a means for attaching one or more fastening devices to said universal mounting apparatus to enable said universal mounting apparatus to be fastened to a surface in a health-care environment.

2. The universal mounting apparatus of claim 1,
a. wherein the fastening device is comprised of one or more straps;
b. Said straps comprising a plurality of raised grooves along the length of the strap, a locking piece, and a release tab;
c. wherein to secure the strap the locking piece catches on one of the grooves and to release the strap, the release tab is pressed to lift the locking piece away from the grooves.

3. The universal mounting apparatus of claim 1 wherein the storage attachment is a urinal holder, said urinal holder comprising four sides, a base, and a top opening wherein the sides, base and opening form an interior space of appropriate volume to hold a standard portable urinal
a. Wherein one of the sides has one or more protruding rails, said rails being particularly molded to reversibly slide into the slots on the universal mounting apparatus to secure the urinal holder to the universal mounting apparatus.

4. A method for storing a portable urinal, said method comprising
a. Providing a urinal holder, wherein said urinal holder is comprised of 4 walls, a base, a top opening, and a plurality of attachment features wherein the attachment features are permanently fixed to one of the walls and the 4 walls, the base, and the top opening form a compartment of an appropriate volume to hold a standard portable urinal;
b. Providing a slide mount, wherein said slide mount is comprised of an anterior surface, a posterior surface, a plurality of attachment receivers, and a plurality of fastening receivers wherein said attachment receivers are permanently fixed to said anterior surface and said fastening receivers are permanently attached to said posterior surface;
c. Providing a fastening strap, wherein said fastening strap is comprised of a plurality of raised grooves along the length of the strap, a locking piece, and a release tab;
d. Sliding the fastening strap into the fastening receiver on the universal slide mount;
e. Wrapping said strap around a surface in a healthcare environment;
f. Tightening and securing said strap to the surface by sliding the locking mechanism over the grooves until the locking mechanism locks in place behind the groove;
g. Sliding the attachment features of the urinal holder into the attachment receivers of the slide mount to reversibly attach the urinal holder to the slide mount.

5. A method for storing equipment in a healthcare environment, said method comprising
a. Providing a plurality of storage attachments representing a variety of shapes and sizes, said storage attachments each having at least one side, said side having one or more protruding rails;
b. Providing a universal mounting apparatus wherein said universal mounting apparatus has an anterior surface, said anterior surface having at least one elongated slot, said elongated slot being particularly molded to couple with the protruding rail of the storage attachment;
c. Placing an article of health-related equipment into one of the storage attachments;
d. Reversibly securing the universal mounting apparatus to a surface in the healthcare environment;
e. Reversibly attaching the storage attachment to a universal mounting apparatus by sliding the rail of the storage attachment into the slot of the universal mounting apparatus.

6. The method of claim 5 wherein the universal mounting apparatus is comprised of an anterior surface and a posterior surface wherein said posterior surface has at least one opening to receive a fastening device which is capable of attaching said universal mounting apparatus to a surface.

7. The method of claim 6 wherein said fastening device is comprised of one or more straps, said straps, said straps comprising a terminal end, a plurality of raised grooves along the length of the strap, a locking piece, and a release tab.

8. The method of claim 7 wherein said universal mounting apparatus is reversibly secured to a substantially vertical surface within a healthcare environment by sliding said straps into the opening on the posterior side of the universal mounting apparatus and tightening the straps in a horizontal configuration around the vertical surface by sliding the locking piece of the strap along the raised grooves until said locking piece catches behind one of said grooves.

9. The method of claim 8 wherein said universal mounting apparatus is detached from the vertical surface by pressing the release tab to lift the locking piece away from the grooves.

10. A customizable healthcare storage system, said system comprising
a. A plurality of storage attachments, wherein each of said storage attachments are particularly shaped to contain an article of healthcare equipment typically found in a healthcare environment, and each storage attachment is comprised of at least one side and one or more attachment features, wherein said attachment features are permanently affixed to said side;
b. A universal slide mount, wherein said universal slide mount is comprised of an anterior surface and a posterior surface, wherein said anterior surface is comprised of a plurality of attachment receivers, wherein said attachment receivers are particularly molded to reversibly couple with the attachment features of each of the storage attachments to enable the plurality of storage attachments to be interchangeably attached to the universal slide mount;
c. A fastening device, wherein said fastening device is reversibly attached to said posterior surface of said universal slide mount to enable said universal slide mount to be fastened to a surface in a healthcare environment.

11. The system of claim 10 wherein one of the plurality of storage attachments is a urinal holder, said urinal holder comprised of four side walls, a base, and a top opening, said side walls, base and top opening forming a compartment of appropriate volume to hold a standard portable urinal.
